(19) United States
(12) Patent Application Publication
(10) Pub. No.: US 2004/0237480 A1
(43) Pub. Date: Dec. 2, 2004

(54) Belly and sheath protector for horses

(76) Inventor: Brenda Jean Keiner, (US)

Correspondence Address: BRENDA JEAN KEINER, 13610 SOUTH 155TH STREET, GILBERT, AZ, 85296, US

(21) Appl. No.: 10/845,753

(22) Filed: May 15, 2004

Related U.S. Application Data
(60) Provisional application No. 60/471,420, filed on May 16, 2003.

(51) Int. Cl. B68B 1/00

(52) U.S. Cl. 54/79.2

(57) ABSTRACT

This invention provides complete coverage of the underside of a horse's belly, such that insects will not be able to access and irritate any portion of the belly, sheath (on male horses) or teat (on female horses) area, including the area between the front legs and the hind legs. The belly protector consists of two main components: A belly piece and a harness. The belly piece is a generally rectangular shaped mesh that is held closely to the horse's belly with a harness. The harness has cross straps, crupper and neck strap, to provide stability and security of the belly piece while it is on the horse. The belly protector protects the sensitive belly area from biting insects that cause severe irritation in some horses. The belly protector can be used in any situation that requires protection for the belly.

### CROSS REFERENCE TO RELATED APPLICATIONS

This application claims benefit of Provisional Patent Serial No. 60/471,420 entitled BELLY PROTECTOR FOR HORSES, filed 16 May 2003, Docket No. 4382-P1.

### STATEMENT REGARDIND FEDERALLY SPONSORED RESEARCH OR DEVELOPMENT

N/A

### REFERENCE TO SEQUENCE LISTING

N/A

### BACKGROUND OF THE INVENTION

This invention relates to accessories of the equine industry. More particularly, the present invention relates to protecting covering devices for horses. Some horses experience severe skin reaction due to the bites of several non-specific species of gnat sized insects. The skin condition is mainly caused by an allergy to the saliva of the biting insect, and the only way to prevent this condition is to apply topical repellant to the belly area of the horse, keep the horse completely away from the insects by keeping him indoors, daily doses of cortisone or anti-histamines based drugs or preventing the insects from coming into contact with the horse's belly by means of a physical covering. Prior art has belly like bands that wrap around under the center of the horse's belly as a part of a full coverage blanket, but provide no protection for the sheath/teat area or between the front and hind legs. These full coverage solutions can also cause the horse to overheat in warm weather, since they are attached to full blankets that cover large portions of the horse. The use of cortisone drugs can have permanent long term negative consequences.

### BRIEF SUMMARY OF THE INVENTION

This invention provides complete coverage of the underside of a horse's belly, such that insects will not be able to access and irritate any portion of the belly, sheath (on male horses) or teat (on female horses) area, including the area between the front legs and the hind legs. The belly protection is held up under the horse with a unique harness design. The soft flexible edging allows the belly piece of conform to the curve of the horses belly line. Biting insects will not be able to bite on the belly, sheath(or teat) area. The sheath pouch will be attached to the belly piece and allow for the male horse to urinate through it.

### BRIEF DESCRIPTION OF SEVERAL VIEWS OF THE DRAWING

FIG. 1 is a Perspective view of a belly protector, according to the present invention, as it appears on a horse.

FIG. 2 is a plan view of the harness of the belly protector of FIG. 1.

FIG. 3 is a plan view of a belly piece of the belly protector of FIG. 1.

FIG. 4 is a plan view of another embodiment of a belly piece according to the

present invention.

FIG. 5 is a plan view of another embodiment of a belly piece similar to the belly piece of FIG. 3.

FIG. 6 is a top plan view (FIG. 6A) and a side plan view (FIG. 6B) of the pouch of the belly piece of FIG. 5.

### DETAILED DESCRIPTION OF THE INVENTION

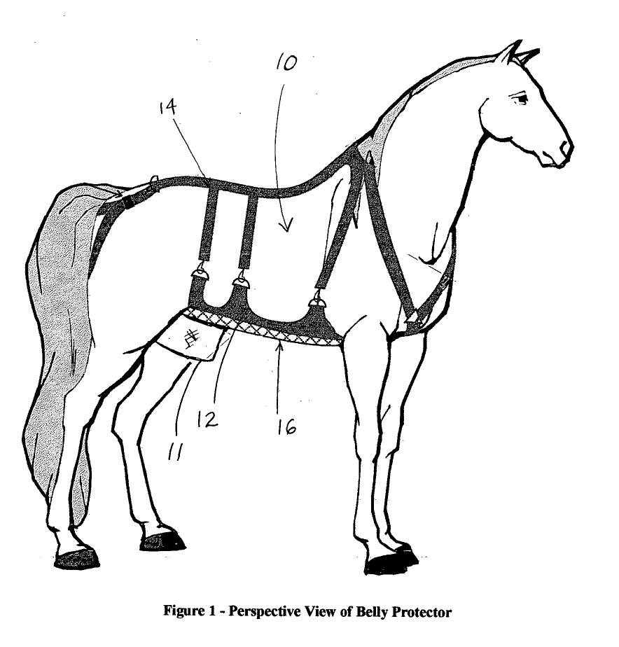

Turning now to the drawings in which like reference characters indicate corresponding elements throughout the several views, attention is first directed to FIG. 1 which illustrates a horse 10 wearing a belly protector generally designated 12. Belly protector 12 includes a harness assembly 14, a belly piece 16 and a sheath protector pouch 11. Belly piece 16 is held in position overlying the belly of the horse 10 by harness assembly 14. Harness assembly 14 can hold the belly piece 16 loosely or relatively snuggly against horse 10, shielding the belly from pests such as flies and other biting insects, and also potentially functioning to hold bandages and/or medication in place in the belly region.

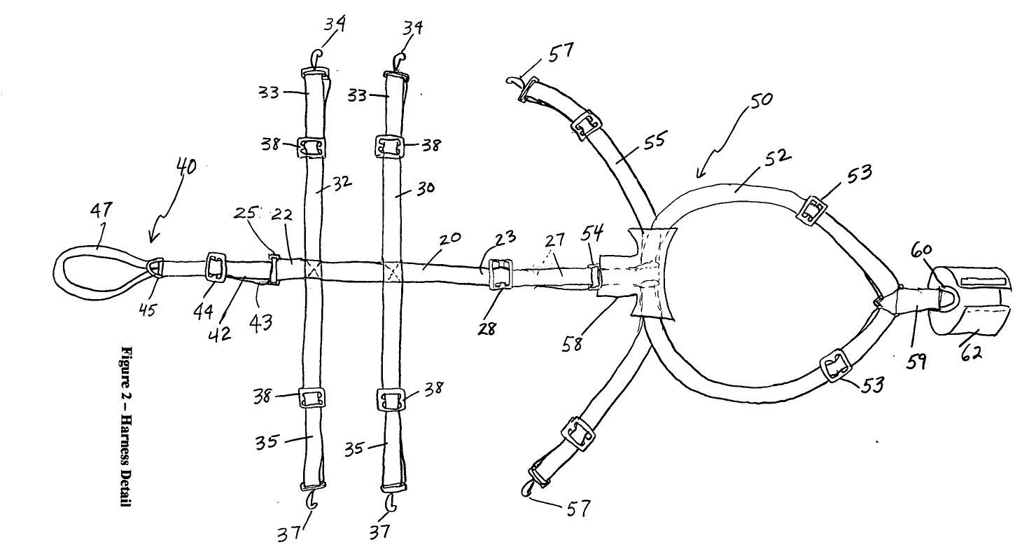

With additional reference to FIG. 2, harness assembly 14 includes a back piece 20 having a rearward end 22 and a forward end 23. Back piece 20 can be substantially any elongated flexible material such as rope, strips of fabric or leather straps, and the like. In the preferred embodiment, back piece 20 is a webbing material of the type often fabricated of nylon or polyester. Back piece 20 terminated at rearward end 22 with a ring 25. Ring 25 can be coupled to back piece 20 in a myriad of different ways, such as by looping rearward end 22 through ring 25 and fastening it back on itself by the use of stitching, adhesives, rivets, etc. Forward end 23 terminates in a loop 27 formed with the use of an adjustable buckle 28. In this manner, loop 27 can be increased or decreased in size as desired, to increase or decrease the effective length of back piece 20. Still referring to FIGS. 1 and 2, cross pieces 30 and 32 are transversely coupled to back piece 20. Cross pieces 30 and 32 each have an end 33 terminating in a fastener element 34 and an opposing end 35 terminating in a fastener element 37. End 33 and opposing end 35 of cross pieces 30 and 32 are adjustable, such as using sliders or buckles 38, to lower or raise fastener elements 34 and 37. In this manner, as will become readily apparent from the description, back piece 20 can be tightened or loosened, and can be adjusted for horse of differing sizes. It will be understood that various types of adjustment devices can be employed, but will be referred to as “buckles” throughout the description. Fastener elements are portions of substantially any type of fastener, particularly those having an element and a complemental element to which it is egagable. Fasteners include fastener elements such as clips, snaps, hook or loop or Velcro buckle, etc., and complemental elements attached to the belly piece for realeasably engaging the element, such as a ring for the clip, and the opposing element of Velcro.

A crupper piece 40 having a forward end 42 terminating in a loop 43 and buckle 44 and a rearward end 45 terminating in a crupper loop 47 is coupled to back piece 20. Loop 43 is adjustably coupled through ring 25 of rearward end 22 of back piece 20. Crupper loop 47 fits under the dock of the tail, aiding in retaining harness assembly in position.

A neck piece 50 having a forward end terminating in a neck loop 52 and adjustment buckles 53 and rearward end terminating in a ring 54, is adjustably coupled to back piece 20. A cross piece 55 is transversely coupled to neck piece 50 and terminate at opposing ends with adjustable fastener elements 57. Neck loop 52 fits around the neck of the horse 10 aiding in retaining harness assembly in position. A junction of cross piece 55 and neck loop 52 on neck piece 50 is covered by a wither pad 58 which is a padded sleeve protecting the withers of horse 10 from this pressure point. A front piece 59 extends from the front of neck loop 52 and terminates in a fastener element 60 such as a ring. A chest pad 62 can be carried on front piece 59 to provide padding for the chest of horse 10. The pads described herein, are preferably formed of neoprene material due to its durability, deformability, softness, etc. However, it will be understood that other padding materials can be employed.

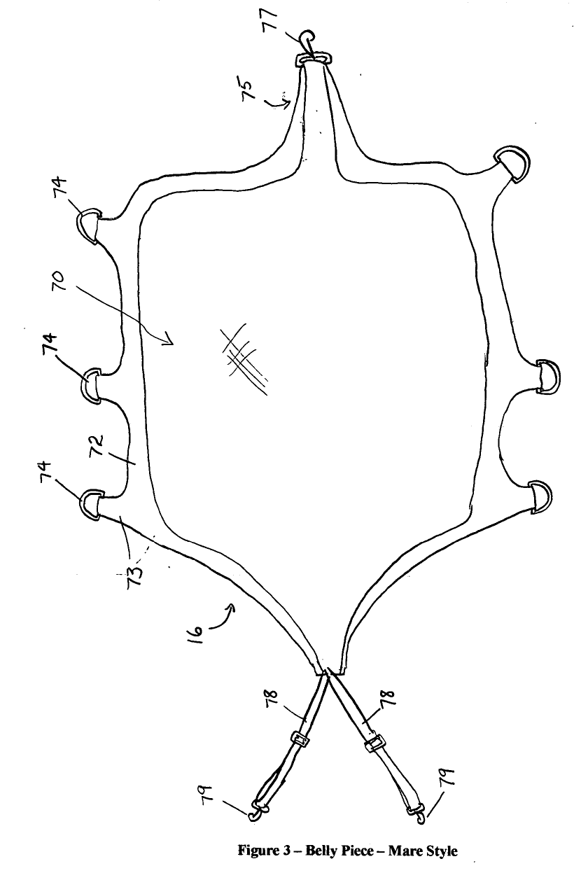

Turning now to FIG. 3, belly piece 16 is illustrated. Belly piece 16 includes a generally rectangular piece of netting material 70 sufficient to exclude biting insects, and edging 72 preferably formed of soft neoprene material. By using neoprene, padding is provided which protects the horse and also conforms to the shape of the horse to provide a fit without gaps. The close fit prevents ingress of biting insects. Three extensions 73 extend from each opposing side of the belly piece 16. Preferably formed from edging 72, and terminate in rings 74, which act as complemental elements to fastening elements 34, 37, and 57 of harness assembly 14. A forward extension 75, formed of netting material 70 and edging 72, extends from a forward end of belly piece 16, terminating in a fastening element 77 (clip). Fastening element 77 releasably engages fastener element 60 of harness assembly 14. A pair of rearward extensions 78 extend from a rearward end of belly piece 16, terminating in adjustable fastening elements 79 (clips). Rearward extensions 78 extend between the rear legs of horse 10 and to either side of the horse's tail to releasably engage fastener element 45 of crupper piece 40.

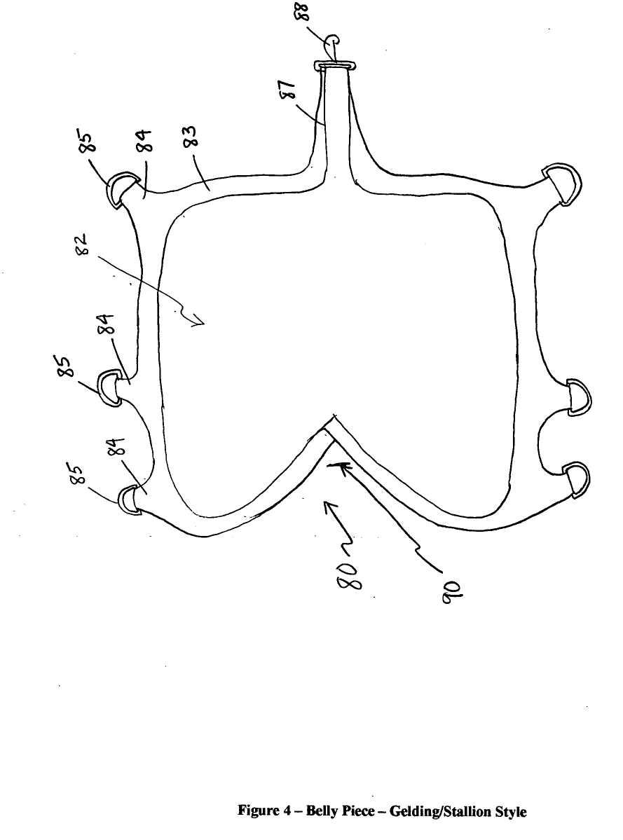

Turning now to FIG. 4, another embodiment of the belly piece, generally designated 80, for use on geldings and stallions, is illustrated. Belly piece 80 includes a generally rectangular piece of netting material 82 sufficient to exclude biting insects, and edging 83 preferably formed of neoprene material for reasons described previously. Three extensions 84 extend from each opposing side of the belly piece 80, preferably formed from edging 83, and terminate in rings 85, which act as complemental elements to fastening elements 34, 37, and 57 of harness assembly 14. A forward extension 87, formed of netting material 82 and edging 83, extends from a forward end of belly piece 80, terminating in a fastening element 88 (clip). Fastening element 88 releasably engages fastener element 60 of harness assembly 14. A rearward end of belly piece 80 is formed in an inwardly directed V-shaped cut-out 90. Cut-out 90 is provided to accommodate the penis of a gelding or stallion and allow unobstructed urination.

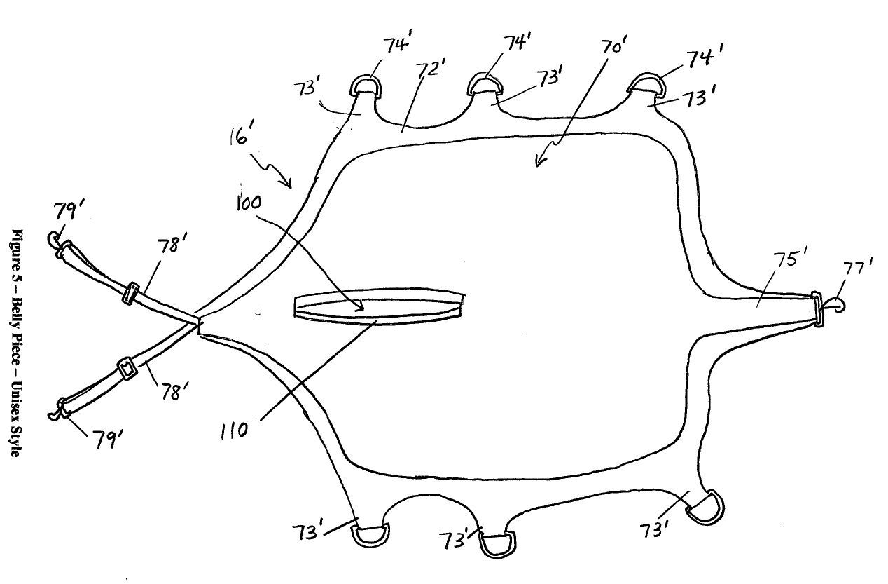

Turning now to FIG. 5, another embodiment of a belly piece generally designated 16′ is illustrated. Belly piece 16′ includes a generally rectangular piece of netting material 70′ sufficient to exclude biting insects, and edging 72′ preferably formed of soft neoprene material. By using neoprene, padding is provided which protect the horse and also conforms to the shape of the horse to provide a fit without gaps. The close fit prevents egress of biting insects. Three extensions 73′ extend from each opposing side of the belly piece 16′, preferably formed from edging 72′, and terminate in rings 74′, which act as complemental elements to fastening elements 34, 37, and 57 of harness assembly 14. A forward extension 75′, formed of netting material 70′ and edging 72′, extends from a forward end of belly piece 16′, terminating in a fastening element 77′ (clip). Fastening element 77′ releasably engages fastener element 60 of harness assembly 14. A pair of rearward extensions 78′ extend from a rearward end of belly piece 16′, terminating in adjustable fastening elements 79′ (clips). Rearward extensions 78′ extend between the rear legs of horse 10 and to either side of the horse's tail to releasably engage fastening element 45 of crupper piece 40.

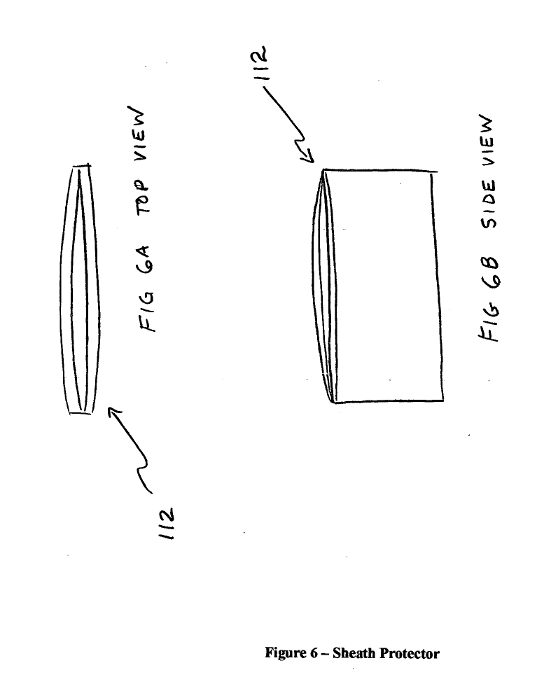

With additional reference to FIGS. 6A and 6B, belly piece 16′ is intended to be used with either mares, geldings, or stallions, and includes an aperture 100 formed through netting material 70′ and bounded by a rim 110 of padding such as neoprene. Aperture 100 is closed by a removable panel 112. Panel 112 is removably attachable to belly piece 16′ to close aperture 100. Attachment is accomplished by the use of a fastener such as Velcro, snaps, hooks, etc. Velcro is preferred since it can fasten panel 112 entirely around the periphery thereof, preventing gaps. Panel 112 is made from lightweight fine mesh and shaped to provide room for the sheath of a male horse. With particular reference to FIG. 6B, panel 112 is cupped to provide the desired space. The removability of panel 112 allows for ease of laundering.

Various changes and modifications to the embodiments herein chosen for purposes of illustration will readily occur to those skilled in the art. To the extent that such modifications and variations do not depart from the spirit of the invention, they are intended to be included within the scope thereof.

What I claim as my invention is:

1. A protective cover for the entire belly and sheath (male horse) and teat (for female horse) area, including protection coming up between the fore legs and between the hind legs of the horse, that is held in place with a harness.

2. The protective cover of claim 1 that uses a soft neoprene type material as an edging to the belly piece.

3. A harness of claim 1 that has cross pieces, tail crupper and neck loop positioned to hold harness in place by taking advantage of the anatomy of the horse.
